(19) United States
(12) Patent Application Publication
(10) Pub. No.: US 2006/0269454 A1
(43) Pub. Date: Nov. 30, 2006

(54) Method and apparatus for generating oxygen

(76) Inventor: Julian Ross, McKinney, TX (US)

Correspondence Address: CARR LLP, 670 FOUNDERS SQUARE, 900 JACKSON STREET, DALLAS, TX, 75202, US

(21) Appl. No.: 11/438,651

(22) Filed: May 22, 2006

Related U.S. Application Data
(63) Continuation-in-part of application No. 10/718,131, filed on Nov. 20, 2003.
(60) Provisional application No. 60/699,094, filed on Jul. 14, 2005.

(51) Int. Cl. A62B 7/08

(52) U.S. Cl. 422/120

(57) ABSTRACT

A method and apparatus are provided for generating Oxygen. Water-soluble chemicals are mixed in water, and the result is medically pure Oxygen. The water-soluble chemicals have long shelf-lives and are non-toxic, not an environmental hazard, not a fire hazard, and not an explosive hazard. Control of the reaction generating the medically pure Oxygen is accomplished with one or more of several alternatives. Storage and transport of the constituents of the reaction are also facilitated, if desired.

### CROSS-REFERENCE TO RELATED APPLICATIONS

This application is a continuation-in part of, and claims the benefit of the filing date of, co-pending U.S. patent application Ser. No. 10/718,131 entitled “METHOD AND APPARATUS FOR GENERATING OXYGEN,” filed Nov. 20, 2003. This application relates to, and claims the benefit of the filing date of, co-pending U.S. provisional patent application Ser. No. 60/699,094 entitled “METHOD AND APPARATUS FOR GENERATING OXYGEN,” filed Jul. 14, 2005. This application relates to the following co-pending U.S. patent applications: Ser. No. 10/856,591 entitled “APPARATUS AND DELIVERY OF MEDICALLY PURE OXYGEN,” filed May 28, 2004; and to Ser. No. 11/158,993, Ser. No. 11/159,016, Ser. No. 11/158,377, Ser. No. 11/158,362, Ser. No. 11/158,618, Ser. No. 11/158,989, Ser. No. 11/158,696, Ser. No. 11/158,648, Ser. No. 11/159,079, Ser. No. 11/158,763, Ser. No. 11/158,865, Ser. No. 11/158,958, and Ser. No. 11/158,867, all entitled “METHOD AND APPARATUS FOR CONTROLLED PRODUCTION OF A GAS,” and all filed Jun. 22, 2005.

### BACKGROUND OF THE INVENTION

1. Field of the Invention

The invention relates generally to oxygen generation and, more particularly, to robust oxygen generation from a solid or liquid.

2. Description of the Related Art

Highly pure oxygen gas is used within a variety of applications. More particularly, medical devices use highly pure oxygen for patient care. However, production or generation, transportation, delivering, usage and storage of oxygen can be both cumbersome and dangerous.

Typical devices today utilize a variety of means to store and produce oxygen. Far and above, the most common apparatus is a compressed gas tank. The compressed gas tank, though, is heavy, requires a regulator, and can be quite dangerous. Oxygen is a very reactive element that can present various hazards. Therefore, compressed tanks of pure Oxygen gas can pose a very realistic fire or explosive hazard.

There are a variety of other Oxygen generation devices that utilize chemical reactions. For example, Oxygen generation canisters are used in passenger aircraft for supplying Oxygen to passengers if the aircraft depressurizes. These canisters, though, can be very unstable devices, especially once the canisters have been deemed to have outlived their respective shelf-lives. In addition, these canisters typically require a spark to initiate the chemical reaction.

Moreover, with both compressed gas and chemical generators, each type typically requires metal containers and safety equipment. These metal containers are highly subjected to corrosion, which could render the container useless. These metal containers may also require ongoing maintenance, and have moving parts. Also, utilization of metal containers can be quite heavy. As a consequence, they can limit the range of applications for usage, or they may not be well-suited to a broad range of applications.

Therefore, there is a need for a method and/or apparatus for generating Oxygen that is more robust and less hazardous and that addresses at least some of the problems associated with conventional methods and apparatuses for producing or generating, transporting, using, delivering or storing Oxygen.

### SUMMARY OF THE INVENTION

The present invention provides an apparatus for generating Oxygen. The apparatus comprises a vessel. An Oxygen producing solution is contained by the vessel. Various approaches can be employed, separately or together, to control the rate of oxygen production, enhance storage of the solution and its constituents and operation of the apparatus.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram depicting an Oxygen generator;

FIG. 2 is a flow chart depicting a first method of producing Oxygen;

FIG. 3 is a flow chart depicting a second method of producing Oxygen; and

FIG. 4 is a flow chart depicting a third method of producing Oxygen.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning mechanical connections, simple inorganic chemistry, and the like, have been omitted inasmuch as such details are not considered necessary to obtain a complete understanding of the present invention, and are considered to be within the understanding of persons of ordinary skill in the relevant art.

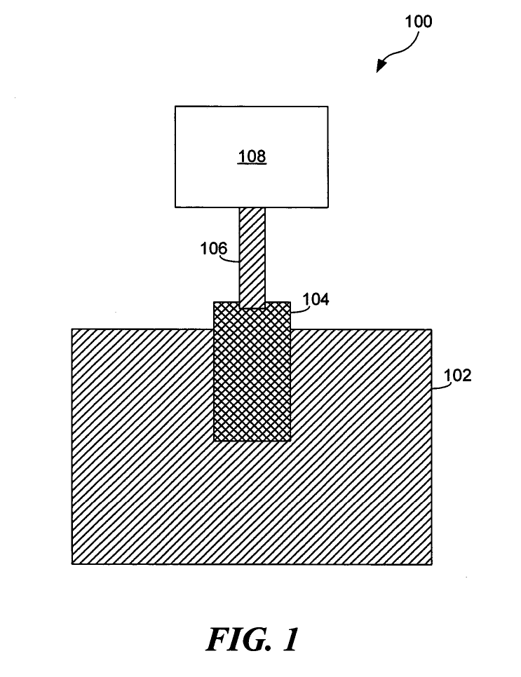

Referring to FIG. 1 of the drawings, the reference numeral 100 generally designates an Oxygen generator. The Oxygen generator comprises a vessel 102, a humidifier 104, output line 106, and a usage device 108.

The vessel 102 contains the compartment where a chemical reaction that produces the Oxygen takes place. The vessel 102 can be composed of a variety of materials. For example, the vessel can be composed of polypropylene, polycarbonate or Acrylonitrile Butadiene Styrene. However, the Oxygen generator 100 only requires that the vessel 102 be composed of a material that can withstand, or which has a conductivity to withstand, the heat generated inside the vessel 102 during the chemical reaction. Typically, the walls of the vessel can vary in thickness. However, the Oxygen generator 100 only requires that the walls of the vessel 102 have a thickness that can withstand the internal pressures that result from aqueous solutions and gas pressure.

The oxygen generated within the vessel 102 is a result of a chemical reaction. The chemical reaction takes place in an aqueous environment, so that upon complete depletion of a limiting reactant, the remaining waste solution can be discarded into conventional waste disposal systems. The waste solution is also not an environmental hazard as defined by generally accepted systems for measuring material properties, such as the Environmental Protection Agency's (EPA) Risk Screening Environmental Indicators Model. For example, the waste solution can be soda ash dissolved in water.

In order to achieve the desired Oxygen generation and environmental acceptability, there are several chemicals that can be utilized. The limiting reactant should be a water-soluble powder or liquid that is non-toxic, not an environmental hazard, not an explosive hazard, not a significant fire hazard, and have a long shelf-life. Non-toxic, not a significant fire hazard, and not an explosive hazard can be defined as compounds that are not deemed to be, respectively, non-toxic, a fire hazard, or an explosive, by a generally accepted system for measuring material properties, such as the Hazardous Materials Information System (HMIS). Also, a long shelf-life can be defined as a material that can be stored for several years when stored below the standard temperature of 860 Fahrenheit (F). For example, Sodium Percarbonate (2Na₂CO₃.3H₂O₂) powder can be an acceptable material that can be dissolved in water. The resulting waste liquid from using Sodium Percarbonate (2Na₂CO₃.3H₂O₂) in an Oxygen generation reaction is an aqueous solution of Soda Ash. There are also a variety of other chemicals that can be used as the limiting reactant, such as Sodium Perborate (NaBHO₃).

These powders or liquids, though, can also require the use of a catalyst. The catalysts, too, should be water-soluble, non-toxic, not an environmental hazard, not an explosive, not a fire hazard, and have a long shelf-life. Typically, a metal-based catalyst can be used to initiate the chemical reaction, combined with a hydrated salt to absorb the heat generated during the reaction. For example, a combination of a Manganese compound and a Sodium-based compound or similar hydrated salt can be used. There are also a variety of catalysts that can be used, such as compounds containing Iron or Iron Oxides and Copper or Copper Oxides.

The flow rate from the generators can be varied. Depending on the amount of the limiting reactant and the amount of the catalyst, the flow rate varies. Generation of Oxygen could occur continuously or for predetermined periods of time depending on the amount of the limiting reactant and the catalyst.

Once a limiting reactant and, possibly, a catalyst have been added to water contained within the vessel 102, then a humidifier 104 allows for the humidification and/or cooling of Oxygen generated within the vessel 102. Typically, the humidifier 104 humidifies, or adds water vapor, to the volume of Oxygen gas being generated. The various configurations of the humidifier can also vary the amount of humidity that can be added to the flow of Oxygen. For example, the humidifier 104 can be configured for use by an individual where the relative humidity of the Oxygen gas is between 15% and 95%. The humidifier can have a variety of configurations that can also vary the temperature of the Oxygen out of the vessel 102.

Attached to the humidifier 104 is a carrying tube 106. The carrying tube carries to a usage device 108. The tube may be a variety of configurations. For example, the carrying tube can be standard medical tubing. Also, the carrying tube can be omitted in order to provide Oxygen to a room or compartment. The usage device can also be a variety of configurations. For example, the usage device can be a standard medical breathing mask.

In another embodiment of the invention, the oxygen releasing agent comprises a combination of Sodium Percarbonate and Hydrated Sodium Carbonate. The combination of Sodium Percarbonate and Hydrated Sodium Carbonate would result in a cooler reaction because of the absorption of heat. At a certain temperature, the hydrated Sodium Carbonate will lose its water molecules. This process is endothermic, and the change in enthalpy associated with the process determines the amount of energy or heat that is absorbed. This endothermic process has the effect of counter-balancing, to some degree, the exothermic reaction associated with the oxygen generation.

In yet another embodiment, additives can be added to the water to influence ambient temperatures. If the ambient temperature of the water increases during the reaction, the reaction can be accelerated. This may result in an undesirable increase in pressure inside the reaction chamber.

Certain additives that lower the freezing point of water can be employed. Antifreeze (ethylene glycol), glycerin, and some ionic compounds like Lithium Chloride (LiCl), Manganese (II) Chloride (MnCl₂), Magnesium Chloride (MgCl₂), some nitrates, some sulfates, and some fluorides can be typically employed. Examples of nitrates include Aluminum Nitrate, Sodium Nitrate, Lithium Nitrate and Calcium Nitrate. For example, to depress the freezing point of water to −5° F., 73.9 grams of Manganese (II) Chloride (MnCl₂) can be utilized per 100 mL of water, based on the solubilities of these compounds at 293K. As a further example still, 83.5 grams of Lithium Chloride (LiCl) could be used per 100 mL of water to depress the freezing point to −5° F.

Some regulatory bodies, such as the Federal Aviation Administration (FAA), can require temperature operating ranges. For example, temperature ranges for operation may be between −5° F. and 165° F. Therefore, the range of temperature operation can be tailored for a specific application.

Additionally, in another embodiment, the catalyst comprises a combination of Manganese Dioxide and Hydrated Sodium Carbonate. An example of a hydrated Sodium Carbonate is Sodium Carbonate Monohydrate. Sodium Carbonate Decahydrate can also be used, but it typically has a much lower melting point, causing it to be less suitable for transportation and storage purposes. The combination of Manganese Dioxide and Hydrated Sodium Carbonate would result in a cooler reaction because of the absorption of heat. At a certain temperature, the hydrated Sodium Carbonate will lose its water molecules. This process is endothermic, and the change in enthalpy associated with the process determines the amount of energy or heat that is absorbed. This endothermic process has the effect of counter-balancing, to some degree, the exothermic reaction associated with the oxygen generation.

Additionally, in another embodiment, a nucleating material can be added to the catalyst. Examples of nucleating materials include sodium tetraborate or disodium tetraborate decahydrate. Depending on the desired result for the reaction, the catalyst can be varied for specific reaction rates and temperatures. This is achieved by varying the composition of the catalyst, the mass of the catalyst and/or its components, as well as the granularity, particle size and flow characteristics of the catalyst.

There are also several ways to store and deliver the oxygen generating material and the catalyst. For example, both the catalyst and the oxygen generating reaction can be in a powder form. For example, Sodium Percarbonate (2Na₂CO₃.3H₂O₂) can be used as an oxygen producing agent in a powder form, and Manganese Dioxide (MnO₂), Sodium Carbonate (Na₂CO₃), Sodium Thiosulfate pentahydrate (Na₂S₂O₃.5H₂O), and Sodium Perborate (Na₂B₄O₇) can be used as catalyst components in a powder form. A powder form would allow for better solubility because of the surface area of the powder exposed to the solvent (water). However, the size of the powder grains can be varied to change the reaction onset, oxygen flow rate, and so forth. For example, the limiting reactant can be of particle size in the 150 micron to 650 micron range.

In another embodiment, the oxygen producing agent or catalyst can be coated. For example, Sodium Percarbonate (2Na₂CO₃.3H₂O₂) can be coated with single or multiple layers of coating for time-release purposes. Each particulate of the oxygen producing agent can be coated with a material that dissolves, which would delay the reaction. Coating the limiting reactant can also increase active oxygen stability, optimize storage and ensiling properties, and insure longer shelf life. Any combination of particulate size and thickness of the coating can be employed depending on the desired reaction time. For example, a limiting reactant with a particle size of approximately 300 micron and a coating level of 6% can be used. The limiting reactant particles should ideally be of consistent size and shape (such as for example a spherical shape), resulting in less attrition during shipping and processing.

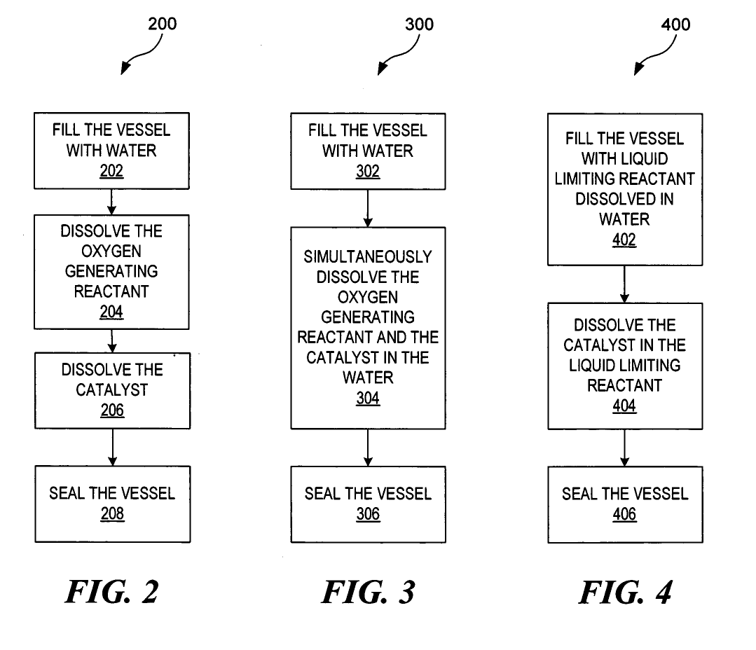

Referring to FIG. 2 of the drawings, the reference numeral 200 generally designates a flow chart depicting a first method of producing oxygen.

Steps 202, 204, 206, and 208 provide a first method for generating Oxygen that utilizes the Oxygen generator of FIG. 1. In step 202, water or water containing an additive is added to the vessel 102 of FIG. 1. In step 204, the limiting reactant powder is added to the water and dissolved. In step 206, the catalyst, if any, is added to the aqueous solution containing the limiting reactant. The three components, reactant, catalyst and water/water with additive can be added in any sequence. In sequences where catalyst is not added last, the potential exists that “flash” may occur. Flash refers to a rapid, possibly uncontrolled reaction onset, which can be undesirable in consumer products. To avoid or reduce the possibility of flash occurring, the catalyst is added last. In step 208, the vessel 102 of FIG. 1 is sealed. The Oxygen generated from the Oxygen generator of FIG. 1 can then be used for a variety of purposes.

Referring to FIG. 3 of the drawings, the reference numeral 300 generally designates a flow chart depicting a second method of producing oxygen. Steps 302, 304, and 306 provide a second method for generating Oxygen that utilizes the Oxygen generator of FIG. 1. In step 302, water is added to the vessel 102 of FIG. 1. In step 304, the limiting reactant powder and the catalyst, if any, are simultaneously added to the water. In step 306, the vessel 102 of FIG. 1 is sealed. The Oxygen generated from the Oxygen generator of FIG. 1 can then be used for a variety of purposes.

Referring to FIG. 4 of the drawings, the reference numeral 400 generally designates a flow chart depicting a third method of producing oxygen. Steps 402, 404, and 406 provide a third method for generating Oxygen that utilizes the Oxygen generator of FIG. 1. In step 402, a liquid limiting reactant dissolved in water is added to the vessel 102 of FIG. 1. In step 404, the catalyst, if any, is added to the liquid limiting reactant. In step 406, the vessel 102 of FIG. 1 is sealed. The Oxygen generated from the Oxygen generator of FIG. 1 can then be used for a variety of purposes.

It will further be understood from the foregoing description that various modifications and changes may be made in the preferred embodiment of the present invention without departing from its true spirit. This description is intended for purposes of illustration only and should not be construed in a limiting sense. The scope of this invention should be limited only by the language of the following claims.

1. An apparatus for generating oxygen, comprising:
a vessel; and
a solution contained in the vessel, the solution being capable of producing oxygen in an exothermic reaction; and
wherein the solution comprises a temperature control agent for absorbing heat from the exothermic reaction, the agent comprising a hydrated substance which loses at least one water molecule in response to an increase in temperature of the solution.

2. The apparatus of claim 1, wherein the temperature control agent produces an endothermic reaction in response to an increase in temperature of the solution.

3. The apparatus of claim 1, wherein the temperature control agent comprises a compound selected from the group consisting of hydrated carbonates, sulfates, thiosulfates and perborates.

4. The apparatus of claim 3, wherein the temperature control agent comprises one or both of a hydrated sodium carbonate compound and a hydrated sodium thiosulfate compound.

5. The apparatus of claim 1, wherein the temperature control agent causes an endothermic reaction that absorbs heat from the exothermic reaction of the solution.

6. The apparatus of claim 1, wherein the oxygen producing solution further comprises a catalyst of metal oxide.

7. The apparatus of claim 1, wherein the oxygen producing solution further comprises an oxygen releasing agent comprising one or both of a percarbonate salt and a perborate salt.

8. The apparatus of claim 1, wherein the solution comprises an aqueous solution and the aqueous solution further comprises an agent for decreasing the freezing point of the solution.

9. The apparatus of claim 1, wherein the solution comprises an aqueous solution and the aqueous solution further comprises an agent for increasing the boiling point of the solution.

10. The apparatus of claim 8, wherein the agent for decreasing the freezing point of the solution is selected from a group consisting of ethylene glycol, glycerin, ionic compounds, nitrate compounds, sulfate compounds and fluoride compounds.

11. The apparatus of claim 10, wherein the agent for decreasing the freezing point of the solution is selected from a group consisting of lithium chloride, manganese (II) chloride, sodium chloride and magnesium chloride.

12. The apparatus of claim 9, wherein the agent for increasing the boiling point of the solution comprises a salt.

13. The apparatus of claim 1, wherein the oxygen producing solution comprises a nucleating material for facilitating the production of oxygen.

14. The apparatus of claim 1, wherein the oxygen producing solution comprises an oxygen producing agent further comprising a particulate at least partially coated with an inhibitor of the oxygen producing reaction.

15. An apparatus for generating oxygen, comprising:
a vessel containing water with temperature control additives; and
plurality of water soluble chemicals that produce oxygen when dissolved in water, wherein each of the plurality of chemicals are initially in a powder form of at least one granular size selected from a plurality of granular sizes, wherein the at least one granular size is selected to provide a desired rate of an oxygen production.

16. The apparatus of claim 15, wherein the plurality of water soluble chemicals further comprises a reactant selected from the group consisting of Sodium Percarbonate (2Na₂CO₃.3H₂O₂), Sodium Perborate (NaBHO₃), and a combination of Sodium Percarbonate (2Na₂CO_{30.3}H₂O₂) and Hydrated Sodium Carbonate.

17. The apparatus of claims 15, wherein the plurality of water soluble chemicals further comprises a catalyst of Manganese Dioxide (MnO₂), Sodium Carbonate (Na₂CO₃), Sodium Thiosulfate pentahydrate (Na₂S₂O₃.5H₂O), or Sodium Borate (Na₂B₄O₇).

18. The apparatus of claim 15, wherein the temperature control additive is selected from a group consisting of ethylene glycol, glycerin, Lithium Chloride (LiCl), Manganese (II) Chloride (MnCl₂), Magnesium Chloride (MgCl₂), a nitrate, a sulfate, and a fluoride.

19. The apparatus of claim 15, wherein the reaction rate of the oxygen producing solution is tempered by the rate of dissolution of an oxygen producing agent or a catalyst.

20. The apparatus of claim 19, wherein the rate of dissolution is slowed by coating the oxygen producing agent or the catalyst with an inhibitor.

21. The apparatus of claim 15, wherein the at least one granular size selected is in the range of 150 microns to 650 microns.

22. An apparatus for generating oxygen, comprising:
a vessel;
a solution for producing oxygen from a chemical reaction; and
a plurality of chemicals that produce oxygen when combined, wherein at least one of the plurality of chemicals is initially in a powder form; and
wherein at least a portion of the particles of the at least one of the plurality of chemicals in powder form is coated with a sealant to inhibit chemical reaction, extend shelf life, enhance stability and/or preserve ensiling properties of particles.

23. The apparatus of claim 22, wherein the sealant comprises alkalimetal citrate.

24. An apparatus for generating oxygen, comprising:
a vessel;
a quantity of water within the vessel;
a plurality of initially separated chemicals within the vessel for dissolving in the quantity of water to create an aqueous solution for producing oxygen; and
an agent dissolved in the quantity of water for decreasing the freezing point and/or increasing the boiling point of the water.

25. The apparatus of claim 24, wherein the agent is for decreasing the freezing point of the solution and is selected from a group consisting of ethylene glycol, glycerin, ionic compounds, nitrate compounds, sulfate compounds and fluoride compounds.

26. The apparatus of claim 25, wherein the agent for decreasing the freezing point of the solution is selected from a group consisting of lithium chloride, manganese (II) chloride, sodium chloride and magnesium chloride.

27. The apparatus of claim 24, wherein the agent is for increasing the boiling point of the solution and comprises a salt.

28. An apparatus for generating oxygen, comprising:
a vessel;
a first group of chemical particles having an average particle size;
a second group of chemical particles having an average particle size;
wherein the average particle size of the first group is greater than the average particle size of the second group; and
wherein the second group of particles reacts more quickly than the first group of particles in a reaction producing oxygen within the vessel.

29. The apparatus of claim 28, wherein the chemical particles comprise sodium percarbonate.

30. The apparatus of claim 28, wherein the first group of chemical particles comprise sodium perborate.

31. The apparatus of claim 28, wherein the vessel is configured to begin reaction of the first group of particles to produce oxygen before beginning reaction of the second group of particles to produce oxygen.

32. The apparatus of claim 28, wherein the vessel is configured to begin reaction of the second group of particles to produce oxygen before beginning reaction of the first group of particles to produce oxygen.

33. The apparatus of claim 28, wherein at least a portion of one of the first and second groups of particles is coated with a sealant.

34. The apparatus of claim 28, wherein the chemical particles are a reactant and/or a catalyst.

35. The apparatus of claim 34, wherein the rate of oxygen production is varied or controlled by varying the relative mass of the catalyst to the mass of reactant.
